(19) United States
(12) Patent Application Publication
(10) Pub. No.: US 2013/0304409 A1
(43) Pub. Date: Nov. 14, 2013

(54) METHODS FOR VALIDATING PLASTIC SCINTILLATING DETECTORS AND APPLICATIONS OF SAME

(71) Applicants: Luc Beaulieu, Quebec (CA); Francois Lessard, Quebec (CA); Sam Beddar, Houston, TX (US)

(72) Inventors: Luc Beaulieu, Quebec (CA); Francois Lessard, Quebec (CA); Sam Beddar, Houston, TX (US)

(73) Assignees: Board of Regents, The University of Texas System, Austin, TX (US); Universite Laval, Quebec (CA)

(21) Appl. No.: 13/891,041

(22) Filed: May 9, 2013

Related U.S. Application Data
(60) Provisional application No. 61/645,583, filed on May 10, 2012.

(51) Int. Cl. G01T 7/00

(52) U.S. Cl. CPC G01T 7/005
USPC 702/104

(57) ABSTRACT

According to one aspect, methods for validating plastic scintillating detectors (PSD) for photon dosimetry and applications of same. In some embodiments, the method includes using at least one PSD to obtain at least one dose measurement, determining at least one PSD correction factor suitable for compensation for variations in energy response of the at least one PSD over the energy range of interest, and determining at least one corrected dose measurement based on the at least one PSD correction factor. In some embodiments, the PSD may be incorporated into a wearable article, such as gloves, eyewear and the like, or used for skin surface measurements.

### RELATED APPLICATIONS

This application claims the benefit of U.S. Provisional Patent Application Ser. No. 61/645,583 filed May 10, 2012 and entitled “METHODS FOR VALIDATING PLASTIC SCINTILLATING DETECTORS AND APPLICATIONS OF SAME”, the entire contents of which are hereby incorporated by reference herein for all purposes.

### TECHNICAL FIELD

The embodiments disclosed herein relate to dosimetry, and in particular to methods of validating plastic scintillating detectors for use with photon dosimetry, especially in the range of energies corresponding to x-ray imaging and interventional procedures, and apparatus and methods using the same.

### INTRODUCTION

Photon dosimetry in the kilovolt (kV) energy range represents a major challenge for diagnostic and interventional radiology and superficial therapy. In particular, there is currently no way to precisely measure skin dose in real time for interventional radiology. As a result, when there are complications during an intervention, a patient may get a non-negligible skin dose that is normally estimated with a +/−50% uncertainty.

Furthermore, staff working with a patient (e.g. medical personnel) may be exposed to radiation and not always adequately shielded. For example, a surgeon's hands normally cannot be obstructed with adequate shielding when the surgeon is working, and thus can be exposed to radiation.

Staff whose hands are likely to be exposed to radiation may wear a ring TLD dosimeter that provides an approximation of the received dose for an extended period. However, this approach provides a retrospective indication of the received dose for an extended period of time.

Eyes are also at risk, as they normally cannot be shielded. Long-term radiation exposures for this organ at risk could result in cataracts developing or other medical problems.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic of a plastic scintillating detector system according to one embodiment;

FIG. 1A is an image of an exemplary plastic scintillation detector used in one example;

FIG. 2 is an image of a system for computing primary incident spectra;

FIG. 3 is a graph showing the

$$\frac{{μ}_{en}}{ρ}$$

ratio between polystyrene and air in the low-energy range;

FIG. 4 is a series of graphs comparing theoretical spectra and measured spectra for various radiologic energy levels;

FIG. 5 is a pair of graphs showing (on the top) Pantak Therapax SXT 150 energy level 4 percent depth dose (PDD) obtained using various detectors, and (on the bottom) relative error to a Monte Carlo (MC) simulation;

FIG. 6 is a pair of graphs showing (on the top) Pantak Therapax SXT 150 energy level 6 percent depth dose (PDD) obtained using various detectors, and (on the bottom) relative error to a Monte Carlo (MC) simulation;

FIG. 7 is a pair of graphs showing (on the top) Pantak Therapax SXT 150 energy level 8 percent depth dose (PDD) obtained using various detectors, and (on the bottom) relative error to a Monte Carlo (MC) simulation;

FIG. 8 is a side view of a patient received in an x-ray imaging device and having plastic scintillating detectors placed to measure skin surface dose according to one embodiment;

FIG. 9 is a perspective view of a patient received in a computed tomograph (CT) imaging device and having plastic scintillating detectors placed to measure skin surface dose according to another embodiment;

FIG. 10 is a schematic view of a plastic scintillating detector received within a patient;

FIG. 11 is a overhead view of a glove incorporating at least one plastic scintillating detector;

FIG. 12 is a front view of a medical practitioner wearing gloves incorporating plastic scintillating detectors;

FIG. 13 is an image of eyewear incorporating a plastic scintillating detector;

FIG. 14 is another image of eyewear incorporating a plastic scintillating detector; and

FIG. 15 is a schematic view of a wearable plastic scintillating detector system according to one embodiment.

### DETAILED DESCRIPTION

Plastic scintillation detectors (PSDs) are promising dosimeters owing to their advantages over other detector types. In particular, in the entire radiotherapy energy range, PSDs are water-equivalent, have excellent reproducibility and stability, are dose-rate independent, and have a high spatial resolution because of their small size.

PSDs have been studied extensively with high-energy photon and electron beams. For high-energy photon beams, in which Compton interactions are dominant, the main advantage of PSDs is their near water-equivalence. This is due to their low effective atomic number (Z_{eff}), which is much lower than that of other detectors, such as thermoluminescent dosimeters, optically stimulated luminescent dosimeters, or metal-oxide field-effect transistors.

However, the water-equivalence of PSDs requires investigation at radiologic photon energies because the photoelectric cross section may be affected by small Z_{eff} differences.

Generally, the dose linearity, reproducibility, and angle independence of PSD are maintained in the diagnostic energy range. However, there appears to be a positive variation in the energy response over the energy range of interest due to water non-equivalence.

At present, no systematic approach appears to have been developed to deal with this variation in energy response over the energy range of interest for plastic scintillating detectors. More particularly, there has been no approach to obtaining PSD correction factors that could be adapted to a wide range of imaging systems (e.g. x-ray systems) with specific peak kilovoltages and added filtrations.

It has been discovered that with low-energy photons, for which large cavity theory (LCT) may be applicable, the cross section ratio between two media is generally equivalent to their mass energy absorption coefficient

$$( \frac{{μ}_{en}}{ρ} )$$

ratio which is energy dependent. For example, polystyrene (which is the main material found in some PSD sensitive volumes) presents a significant variation in the

$$\frac{{μ}_{en}}{ρ}$$

ratio between water and air below 100 keV.

To compensate for this energy response, a method based on LCT was developed. This method was then validated using Monte Carlo simulations. The dose to soft tissue, bone, or any other media can then be extracted from this adjusted PSD measurement.

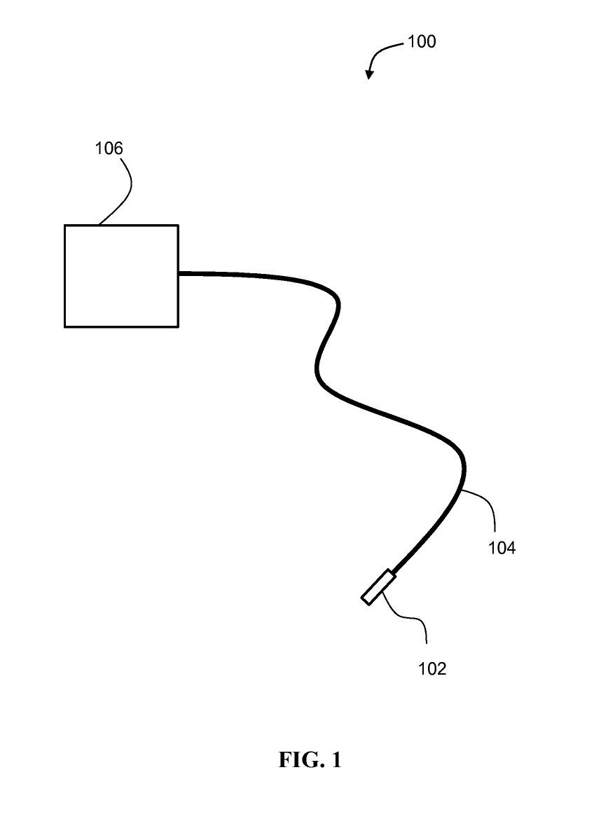

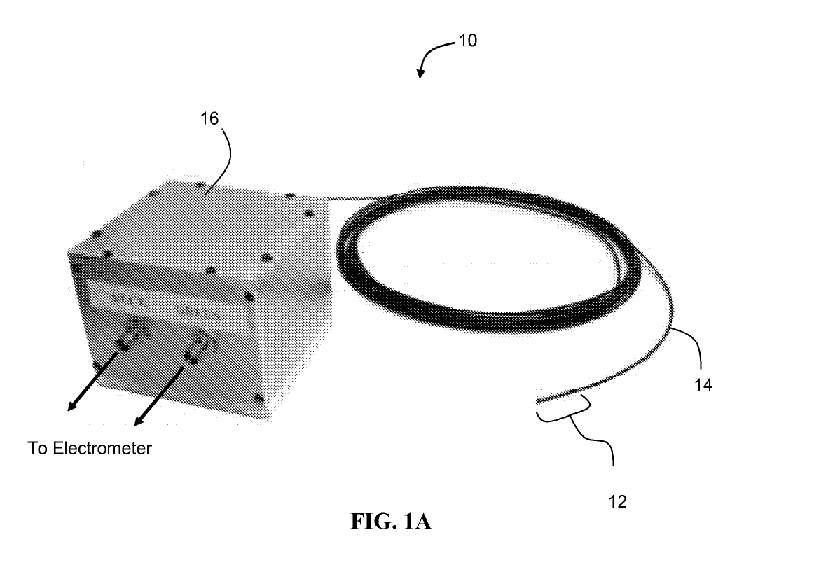

Turning to FIG. 1, illustrated therein is a schematic of a generic plastic scintillating detector (PSD) system 100 according to one embodiment. The PSD system 100 generally includes a plastic scintillating detector (PSD) 102 that is optically coupled to a photodetector 106 via a light guide 104 (e.g. an optical fiber or other suitable light guide).

### EXAMPLE

In one example, a Therapax SXT 150 (Pantak Inc., Branford, Conn.) imaging device was used to deliver radiation. The beam ranged from 80 kVp (1.26 mmAl first half-value layer [HVL]) to 150 kVp (1.17 mmCu first HVL), with filtration thicknesses varying from 0.8 mmAl to 0.2 mmAl+1.0 mmCu (see Table 1). The tube anode was made of tungsten, had a 40° angle, and had an inherent filtration of 2 mm of beryllium. Measurements were performed in a 3-cm-diameter field at a source-to-surface distance (SSD) of 15 cm.

Table I shows available energy level specifications. Dose rates were measured with an ionization chamber with no build-up cap.

FIG. 1A shows the plastic scintillating detector (PSD) system (indicated generally as 10) used for this example. This PSD system 10 includes a PSD made of a BCF-60 green scintillating fiber (indicated generally as 12) with a diameter of 1 mm and a length of 10 mm (Saint-Gobain Crystal, Paris, France). For this test the plastic scintillating fiber 12 had been polished using polishing films with decreasing grain sizes (5 μm, 3 μm, 1 μm, and 0.3 μm).

The scintillating fiber 12 was coupled to an 8-m-long, polished, clear optical fiber 14 (Eska GH-4001; Mitsubishi International Corporation, New York, N.Y.).

The optical fiber 14 was aligned to the photodetection surface using an SMA connector. Light was collected by a polychromatic photodiode (Sensor-ICs True Color Sensor; MAZeT GmbH, Jena, Germany) placed inside a light-tight aluminium box 16. This photodetector converts light to an electrical current in 3 optical channels (red, blue, and green) without applied bias.

Because of the absence of Cerenkov radiation production in the investigated energy range (<150 keV), no spectral correction was applied to the readings.

Two output channels, based on 2 optical filters, were present: blue and green. In this example, only the photodiode's green output was used because it filtered the fluorescence noise signal, which is distributed around the blue part of the spectrum (peaked at 460 nm).

### Primary Incident Spectra

Computed Spectra

Primary incident spectra were determined with the open source software SpectrumGUI. As shown in FIG. 2, in a window of SpectrumGUI the user can choose the x-ray tube type and then define the peak kilovoltage, current, and filtration. The corresponding fluence spectrum, exposition at 1 m, half-value layer (HVL), and effective energy are then displayed in less than a second.

For this experiment, the inherent filtration, anode angle, and composition values were adapted for the x-ray tube used. Peak tension and filtration were set for each energy level to obtain the associated fluence spectra.

Measured Spectra

To confirm the validity of the computed spectra, direct measurements were made with a commercial CdTe spectrometer detector (XR-100-CdTe triple stack; Amptek Inc., Bedford, Mass.). The thickness of the sensitive volume was 2.25 mm, which provided detection efficiency of about 50% for 150-keV photons.

A Monte Carlo-based correction procedure (stripping method) was applied to correct the detector response for spurious effects such as photoelectric detection efficiency, cadmium and tellurium K-escape, and partial energy deposition.

Correction for Medium Difference

According to the American Association of Physicists in Medicine Task Group 61 (TG-61), reference dosimetry should be based on in-air kerma measurements for the low-energy range. Dose is assumed to be equal to the kerma because the radiative losses by secondary charged particles are less than 0.1% for photons below 300 keV.

For the sizes that were considered in this example, large cavity theory (LCT) was applicable for this energy range because of the short electron range relative to the detector sensitive volume.

At diagnostic x-ray energies, the deposited dose is highly dependent upon the medium. Because in this example the PSD sensitive volume was made of polystyrene and the reference dose rates were measured in free air, the dose in the medium, D_{med}, can be expressed as:

$${D}_{med} ≅ {K}_{med} = {K}_{air} \cdot {[ \frac{\overline{{μ}_{en}}}{ρ} ]}_{air}^{med} .$$

where K_{med} is the kerma in the medium of interest and Kₐᵢᵣ is reference air kerma. Therefore, to relate a measurement made with a PSD, M_{PSD}, to a dose in air, one should apply the following equation:

$${D}_{air} = {{M}_{PSD} [ \frac{\overline{{μ}_{en}}}{ρ} ]}_{polystyrene}^{air} .$$

However, because the radiation used was not monoenergetic, exact correction factors were not straightforward to obtain, prompting the testing of various other methods.

Effective Energy Correction Factor

Every spectrum can be approximated to a monoenergetic beam corresponding to its effective energy. One method to obtain this value experimentally is to measure the beam HVL and obtain its effective energy from published data. The correction factor C_{LCT E}_{_{eff}} becomes the

$$\frac{{μ}_{en}}{ρ}$$

ratio taken at the effective energy:

$${C}_{LCT {E}_{ff}} = {[ \frac{\overline{{μ}_{en}}}{ρ} ]}_{air}^{med} = \frac{{[ \frac{{μ}_{en}}{ρ} ( {E}_{eff} ) ]}_{med}}{{[ \frac{{μ}_{en}}{ρ} ( {E}_{eff} ) ]}_{air}} \qquad ( 1 )$$

where

$$\frac{{μ}_{en}}{ρ} ( {E}_{eff} )$$

is the mass energy-absorption coefficient taken for the corresponding effective energy.

However, this method is correct only if

$${[ \frac{\overline{{μ}_{en}}}{ρ} ]}_{air}^{med}$$

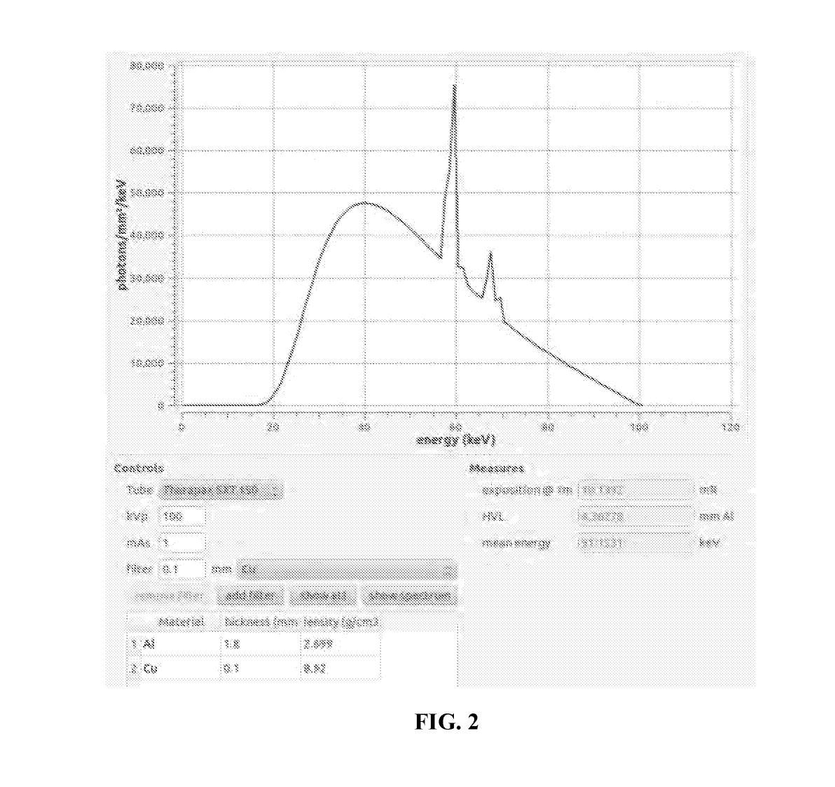

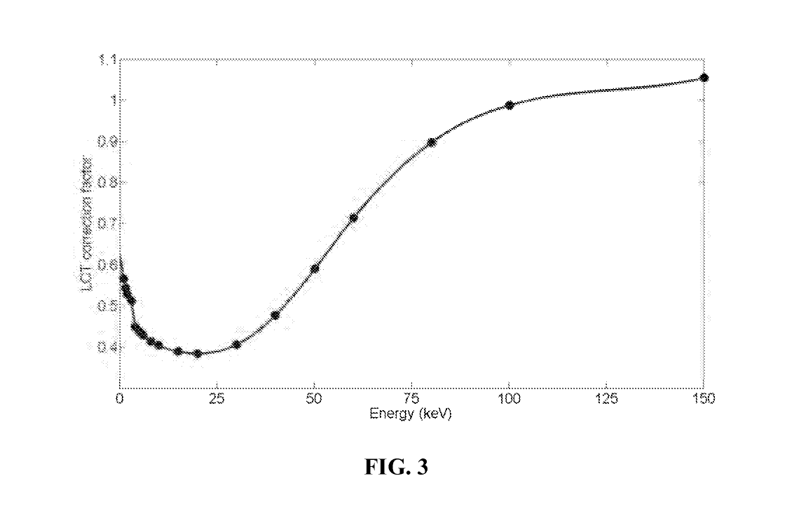

is linear within the energy range. With polystyrene as the medium, this assumption was partially false, as shown in FIG. 3 (taken from the National Institute of Standards and Technology). According to LCT, this ratio is the correction factor to obtain the deposited dose in polystyrene from a measurement in air.

Correction Weighted on Spectra

Another correction method used was to average

$${[ \frac{\overline{{μ}_{en}}}{ρ} ]}_{air}^{med}$$

over the complete fluence spectra:

$${C}_{LCT spectra} = {[ \frac{\overline{{μ}_{en}}}{ρ} ]}_{air}^{polystyrene} = \frac{{\int }_{0}^{{E}_{max}} {( \frac{{μ}_{en}}{ρ} ( E ) )}_{polystyrene} \cdot E \cdot Φ ( E ) \cdot d E}{{\int }_{0}^{{E}_{max}} {( \frac{{μ}_{en}}{ρ} ( E ) )}_{air} \cdot E \cdot Φ ( E ) \cdot d E} , \qquad ( 2 )$$

where Eₘₐₓ is the maximum incident photon energy and Φ(E) is the fluence spectrum.

Eq. 2 was used to obtain correction factors for the computed and measured spectra as described above. Because

$${[ \frac{\overline{{μ}_{en}}}{ρ} ]}_{air}^{polystyrene}$$

varies slowly with energy (see FIG. 3), some discrepancy between computed and measured spectra may not substantially affect the correction factor.

Correction Based on Monte Carlo Simulation

Monte Carlo simulations were performed to confirm the LCT method approximations. In particular, a phase space made of an isotropic point source collimated to a 3-cm-diameter beam at an SSD of 15 cm was modeled. Both simulated and measured spectra were used. For each energy level and spectrum, a simulation of 4×10⁸ photons impinging on a fully modeled PSD in air was run.

The simulation geometry consisted of a 10-mm-long scintillating fiber made of a 0.97-mm-diameter polystyrene core and surrounded by a 0.015-mm-thick poly(methyl methacrylate) (PMMA) cladding coupled to a long PMMA clear fiber with a 0.99-mm diameter. The entire assembly was surrounded by a 0.6-mm-thick polyethylene jacket.

Dose was scored in the PSD's polystyrene core as well as in an equivalent volume made of air, in the absence of the PSD. The Monte Carlo correction factor, C_{MC}, was defined as

$${C}_{MC} = \frac{{D}_{polystyrene}}{{D}_{air}} . \qquad ( 3 )$$

The statistical error is one standard deviation estimated with the batch method. With these simulations, it is possible to consider the effect of some parameters that are neglected in LCT, such as beam divergence and its finite diameter, the presence of a PSD jacket, scattered radiation, beam attenuation through the detector, and electron range.

### PSD Measurements

Absolute Dose Rate Determination

For the reference dose rate, measurement was made with a calibrated Farmer NE2571 ionization chamber (NE Technology Limited, Berkshire, England). The chamber was calibrated for various HVL beam qualities, and the calibration factors were interpolated for our measured HVLs.

In this experiment, only energy levels 4 to 8 were used because no calibrations were available for lower beam qualities. Measurements were taken in a 3-cm-diameter beam at an SSD of 15 cm. Reference air dose rates were obtained following the TG-61 protocol for low-energy x-rays.

Under the same conditions, the ionization chamber was replaced with the PSD. Given the dose rate in terms of air kerma, the PSD response A (in pC/Gy) was calculated for all energy levels as

$$A = \frac{Q}{{D}_{polystyrene}} = \frac{Q}{{K}_{air} \cdot C} , \qquad ( 4 )$$

where Q is the charge (in pC) measured by the photodiode green channel and C is the applied correction factor (either from Eq. 1, 2, or 3). The energy dependence of A was characterized according to each correction factor obtained above.

Percent Depth Dose (PDD) Measurements

PDD was measured with a 3-cm-diameter beam at a SSD of 15 cm in an MT150M water phantom (Civco, Kalona, Iowa). A constant irradiation time of 1 minute was chosen for all depths. Data were taken for energy levels 4, 6, and 8. The PSD was positioned perpendicularly to the x-ray tube axis to minimize the heel effect.

Because these measurements were relative to the surface dose, the energy dependence would be caused by beam hardening and scattered radiation variation with depth. To obtain the primary and secondary photon fluence spectra as a function of depth, Monte Carlo simulations were conducted using the EGSnrc/FLURZnrc code.

The same beam setting as above was used. With the calculated spectra as a function of depth, the PSD response was converted to dose-to-water for each depth,

$${PSD}_{corrected} ( z ) = {PSD}_{raw} ( z ) \cdot {[ \frac{\overline{{μ}_{en}}}{ρ} ]}_{polystyrene}^{water} ( z ) . \qquad ( 5 )$$

PDD was also measured using Gafchromic EBT2 film (International Specialty Products (ISP), Wayne, N.J.), which was calibrated at energy level 6. The same calibration curve was used for other energy levels. The film was placed vertically in a water phantom to measure the dose at any depth along the beam central axis. PDD measurements were further compared with the data from a PTW chamber.

Monte Carlo simulations performed using the EGSnrc/DOSRZnrc code were considered as the reference data for comparison purposes.

### Results

Primary Incident Spectra

Spectra predicted with SpectrumGUI were consistent with measured spectra for every energy level, as shown in FIG. 4. In particular, FIG. 4 is a series of graphs comparing theoretical spectra (computed with SpectrumGUI) and measured spectra (with CdTe detector) spectra for various energy levels 4, 5, 6, 7, and 8. Each area under the curve is normalized to 1. The bottom right panel shows computed half-value layer (HVL) comparison for each energy level, and shows that the HVLs obtained from these spectra were also in good agreement with one another.

Correction for Medium Difference

The correction factors as defined above are presented in Table II, which lists Correction factors (C) for plastic scintillation detectors, obtained using large cavity theory (LCT) and Monte Carlo (MC) simulation. The LCT factor errors correspond to the ±1.5% error range estimated by the American Association of Physicists in Medicine Task Group 61. Monte Carlo errors correspond to ±1 standard deviation of the simulation estimated with the batch method. Correction factors have no unit.

These factors differed considerably between energy levels. In particular, correction factors varied by a factor of 2 between energy level 4 and energy level 8. The LCT correction factors based on the effective energy most differed from those obtained with other methods.

The C_{LCT spectra} factors obtained using theoretical spectra were consistent with those obtained using experimental spectra within the ±1.5% error range suggested by the TG-61 document. Monte Carlo correction factors were also consistent with LCT correction factors.

These results suggest that LCT was a reasonable approximation and that the primary cause of error among the correction factors was the method used to evaluate the spectra.

Absolute Dose Rate Measurements

Table III shows the PSD calibration factors (in pC/Gy) for each energy level (Eq. 4) according to each correction factor. The “no correction” column corresponds to the uncorrected PSD response to dose in air. The coefficient of variation (COV) for the parameter is presented for each method.

The differences between them were caused by the energy response of the scintillator. Without any correction, the PSD response varied by more than a factor of two over the analyzed energy range, demonstrating that the polystyrene PSD core was not equivalent to air. Even the simplest corrected energy response (effective energy) was much more stable between 80 kVp and 150 kVp with a coefficient of variation (COV) of 4.5% about its mean value.

The corrected energy responses weighted on the theoretical and experimental spectra were almost energy independent, with COV values of 2.1% and 2.9%, respectively.

For the Monte Carlo correction factor, the COVs decreased to 1.4% with theoretical incident spectra and 2.7% with experimental spectra.

PDD Measurements

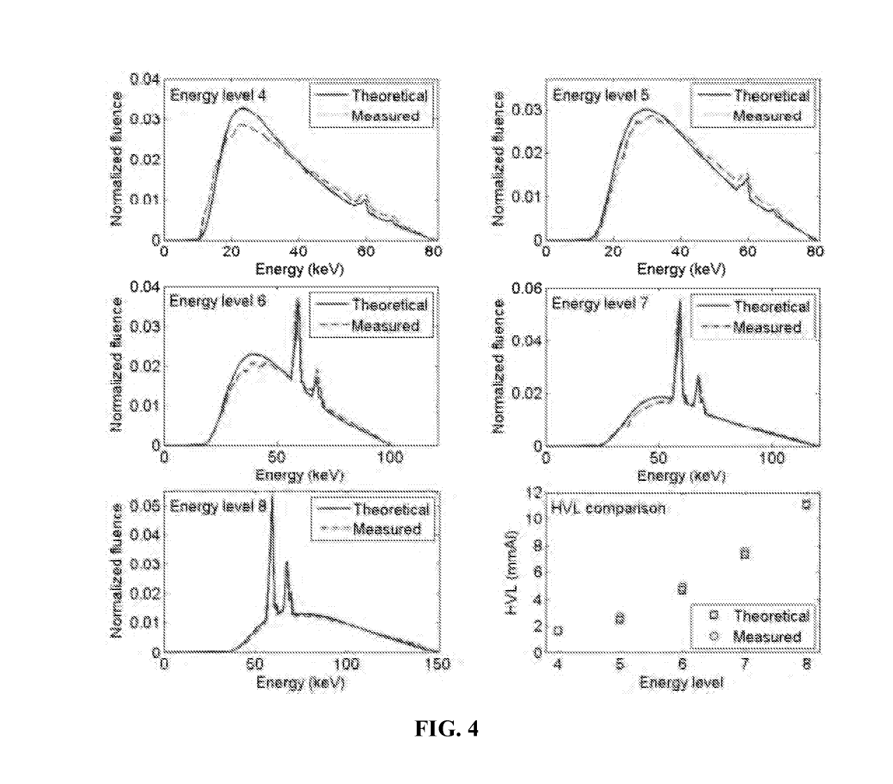

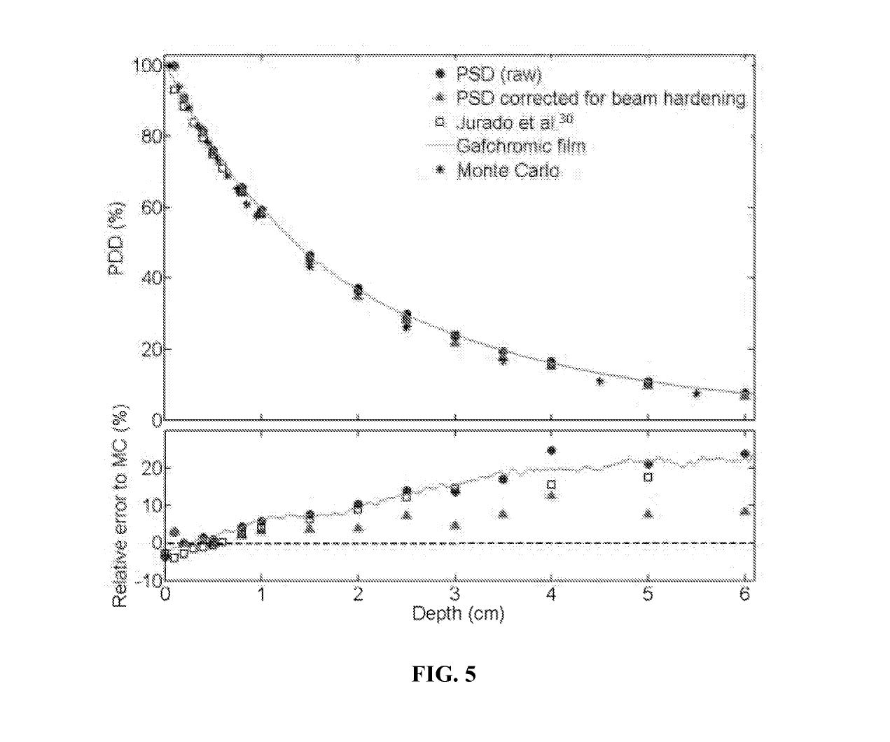

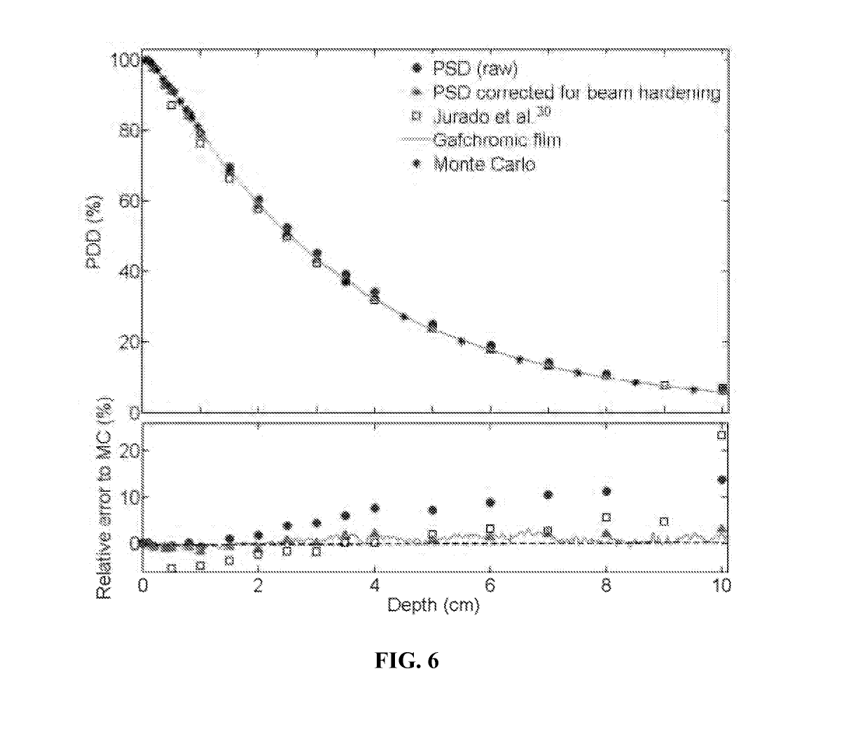

PDD measurements obtained using the various methods are plotted in FIGS. 5, 6, and 7 for energy levels 4, 6, and 8, respectively. When the PSD raw data were compared with Monte Carlo simulations, the differences increased with depth, up to 13% at 10 cm with energy level 6. The LCT correction method for beam hardening partially compensated for this effect, reducing the difference to 3%.

The data from Jurado et al. (D. Jurado, T. Eudaldo, P. Carrasco, N. Jornet, A. Ruiz, and M. Ribas, “Pantak Therapax SXT 150: performance assessment and dose determination using IAEA TRS-398 protocol,” Br. J Radiol. 78, 721-732 (2005)) lie between the PSD raw data and the PSD corrected data.

Film measurements showed the best agreement with the Monte Carlo data for energy level 6 and the worst agreement for energy level 4. This result may have been obtained because the calibration curve linking optical density to dose obtained at energy level 6 was used for each beam quality.

### Discussion

In the investigation of the performance of a PSD over 5 beam qualities ranging from 80 kVp to 150 kVp, it was observed that a spectrum-weighted correction based on LCT that accounts for medium composition differences could be applied to compensate for the energy dependence. In these experiments, the spectrum was easily obtained with x-ray spectrum simulation software, and the results were in good agreement with the Monte Carlo simulations. However, for PDD measurements, it was important to consider beam hardening in the analysis.

The results from the measured spectra were quite similar to those of the spectra predicted by SpectrumGUI, and the correction factors extracted from the theoretical and experimental spectra are in agreement within ±1.5%.

SpectrumGUI has proven to be easily adaptable open-source software, providing reliable spectra for the diagnostic energy range. Considering the complexity of measuring spectra, computed spectra could be used for further application in the field of radiology.

In particular, it could be interesting to obtain every spectrum with complete Monte Carlo simulation to rigorously benchmark the results. However, the gain in precision may be eclipsed by the uncertainty of interpolated

$$\frac{{μ}_{en}}{ρ}$$

values using a cubic spline between 10 keV and 150 keV in the National Institute of Standards and Technology tables.

The correction factors obtained using effective energy (C_{LCT E}_{_{eff}}) were the simplest to obtain, but this method seems to be the most inaccurate because the values were quite different from those obtained with the Monte Carlo simulation.

Calculating C_{LCT spectra} instead of C_{LCT E}_{_{eff}} is slightly more complex, but the complexity appears to be justified by the increased gain in accuracy.

C_{LCT spectra} values were consistent with those obtained in the Monte Carlo simulations, showing that the presence of the PSD jacket had negligible effects and that LCT was applicable. Keeping a clinically applicable approach in mind, the best compromise between complexity and accuracy may be to use LCT factors weighted on spectra obtained from a tool such as SpectrumGUI.

A single energy response factor A (=39±1 pC/Gy) may be applicable to the detector for the energy range most widely used in radiology and superficial x-ray therapy. The main source of uncertainty comes from the measurement of air kerma with the ionization chamber. TG-61 states that this error is approximately 3%, which is similar to the energy response COV that was obtained.

When corrected for medium differences with LCT, the PSD did not present any energy dependence or quenching effects in the analyzed energy range. The narrow window of diagnostic energies allowed for the assumption that the quenching effect was constant and thus did not affect the measurements.

The stability of the corrected data also indicates that fluorescence production, if present in the green channel, was constant over the energy range studied.

For surface measurements, the back-scatter factor may be measured with PSDs, but because the scattered radiation energy spectrum differs from the spectrum of primary photons, Monte Carlo simulation should be used to obtain the scattered radiation energy spectrum.

Beam hardening showed a non-negligible effect on the PSD response. The good match obtained between Monte Carlo simulation and PSD corrected data shows that the correction method applied was valid.

Gafchromic films might have the potential to serve as good reference detectors as long as a calibration curve can be obtained for each energy level and batch of film.

For energy level 4, the substantial over-response of each detector compared with Monte Carlo in these experiments suggests that the simulation uses a spectrum slightly softer than the real spectrum.

Using the LCT-based correction methods as generally discussed herein, PSDs appear to have the potential to be used for real-time measurements in the diagnostic radiology and superficial therapy energy range, including for in vivo measurements and surface measurements of a patient, as discussed further below.

### Applications

The teachings herein compensate for PSDs variations in energy response over the energy range of interest, allowing them to be considered as good candidates for various medical applications. In particular, such compensated PSDs may be suitable for measuring radiologic skin dose of patients in real time without creating artifacts inside the images.

Such compensated PSDs could also be used to measure doses received by medical staff. For example, surgeons could have a real time detector using PSDs to determine when they are irradiated (and the magnitude of the dose), particularly on areas that are often poorly shielded, such as the hands and eyes.

To compensate the Z_{eff} difference between various media, a Burlin cavity theory approximation for large cavity may be applied (e.g. large cavity theory, LCT). Thus, the actual adjusted dose received can be expressed as

$$D = Φ ( E ) E \frac{{μ}_{en}}{ρ} ( E ) ,$$

where D is the dose and Φ(E) is the normalized fluence spectra incident to the PSD.

The spectra may be simulated using software and confirmed with experimental measurements. To calculate the dose in the medium of interest (such as water, air or soft tissues), a mass energy absorption coefficient ratio can be applied. Since dose is measured in the PSD core (e.g. a polystyrene core), the ratio can be expressed as:

$${D}_{med} = {{D}_{poly} [ \frac{\overline{{μ}_{en}}}{ρ} ]}_{poly}^{med} .$$

where D_{med} is the dose in the medium of interest and D_{poly} is the dose observed the PSD core. The PSD response seems to be independent of photon energy in the studied thin energy window.

In some embodiments, the energy spectra will be critical to getting the proper

$$\frac{{μ}_{en}}{ρ}$$

factors.

### Patient Dose Measurement

Compensation for energy variations in PSDs may allow PSDs to be used to measure skin doss. For instance, a patient's skin dose may be measured by placing or fixing one or more PSDs on patient's skin, typically where the x-ray beam is incident. The PSDs can then measure in real time (or substantially real time) the surface dose to a region of interest for different beam angles.

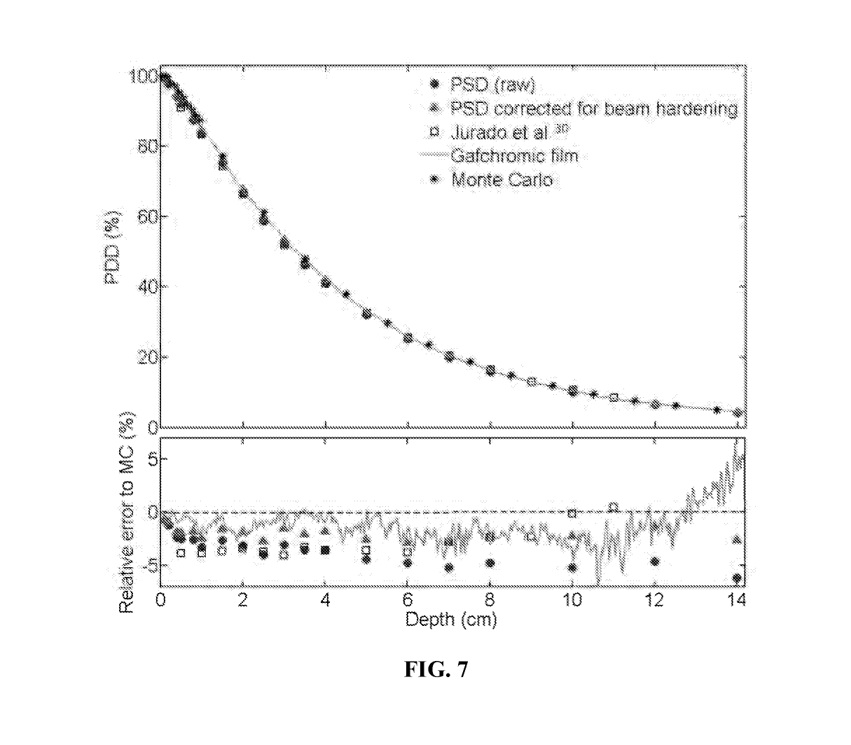

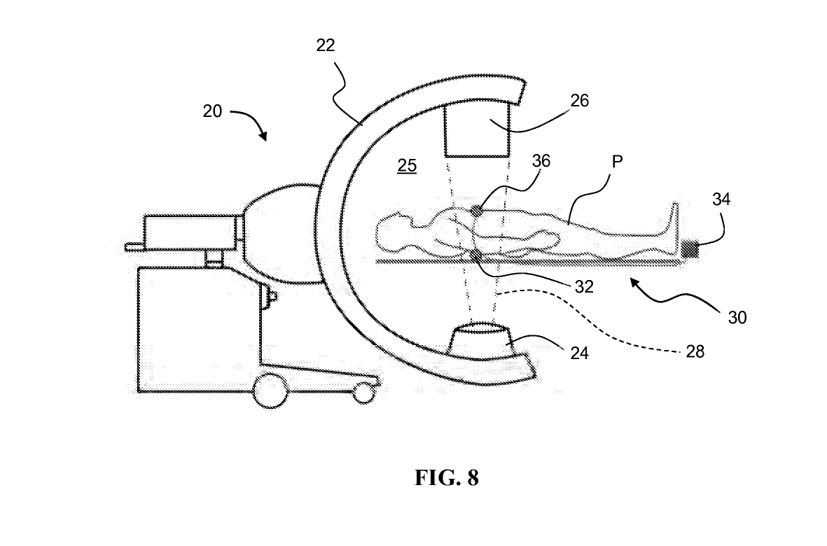

One example is shown in FIG. 8, where a patient P is received in an imaging device 20 such as interventional radiology x-ray device. As shown, the patient P is generally positioned within an opening 25 of a supporting frame 22, between a radiation source (e.g. a cathode) 24 and radiation target (e.g. an anode) 26 of the imaging device 20.

In this example, radiation 28 is incident from bottom cathode 24, and with an angle that can be adjusted along 3 axes.

A PSD measurement system 30 can include one or more PSDs 32, 36 placed within the radiation field 28. In particular, a first PSD 32 may be placed between the bed or other support surface and the patient P to measure skin surface dose of the patient P. Because the radiation field 28 is quite large, the PSD 32 will be in the field 28 for most of the beam orientation. In some cases, the PSD 32 should be placed where the dose received by patients is highest, although other locations could be used.

Another PSD 36 could be placed between the patient P and the anode 26 of the imaging device 20 to measure an exit dose.

The PSDs 32, 36 can be in communication with a control unit 34, which may include the photodetector. In various embodiments, the control unit 34 may include a processor or other suitable hardware that can store measured doses, determine corrected dose measurements (e.g. by applying one or more correction factors according to the teachings herein), and transmit corrected dose measurements to another entity of interest (e.g. a server in a hospital). In some embodiments, the control unit 34 may also display corrected dose measurements (e.g. using an LCD display), or may activate an audible or visual alarm when a particular dose measurement is observed.

In some embodiments, one or more of the PSDs 32, 36 can send signals to a photodetector that communicates wirelessly with the control unit 34. For example, the control unit 34 may be carried by or worn by a medical staff, and receive wireless signals (e.g. via WI-FI communication, near field communication, Bluetooth communication, etc.) about the dose measurements of a particular patient.

FIG. 9 shows a similar setup that can used with a computed tomograph (CT) imaging device. In this embodiment, the PSD measurement system 30 includes additional PSDs 38 placed around the patient P.

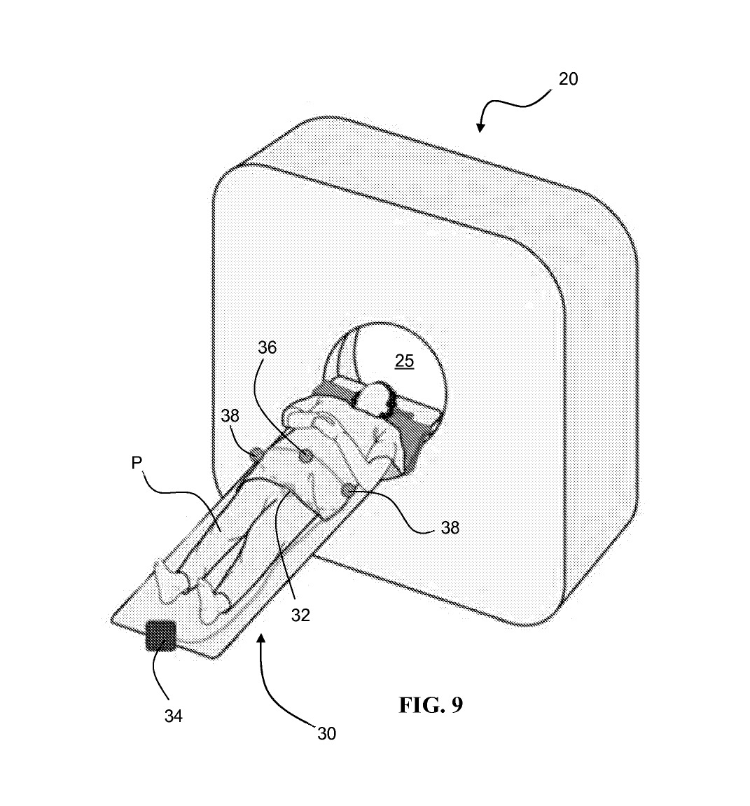

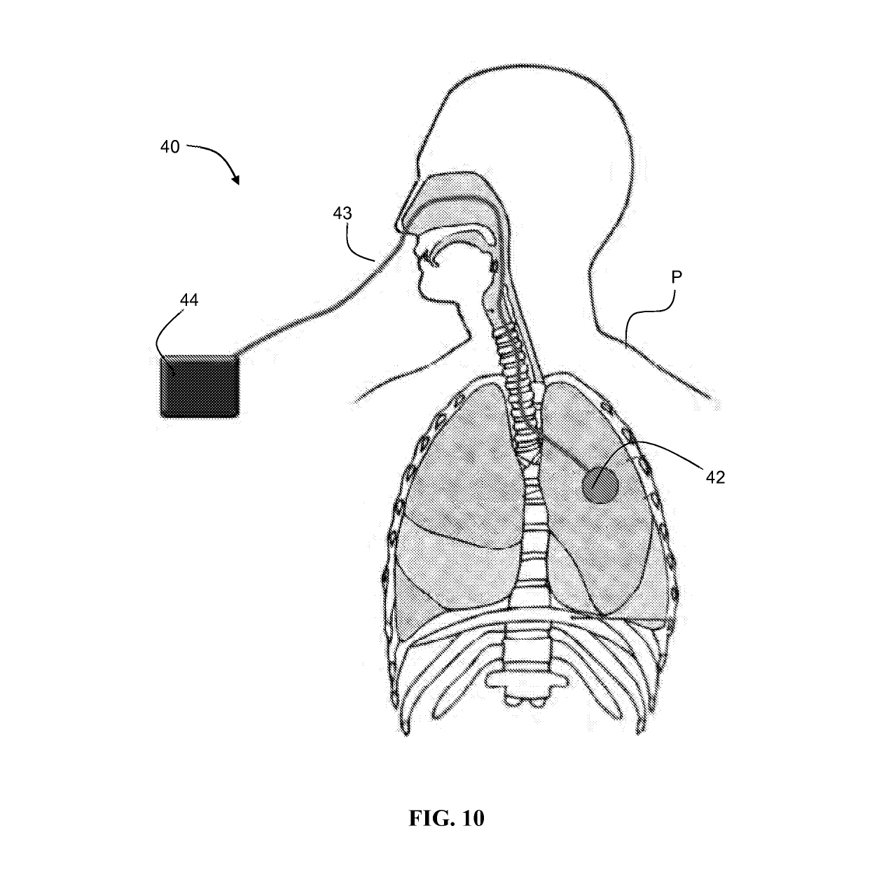

In some embodiments, the teachings herein could also be applied as in vivo (in-patient) detectors. For example, as shown in FIG. 10, a PSD measurement system 40 could include an in vivo PSD 42 connected to a control unit 44 via a wire 43.

The small size of the PSD 42 (e.g. around 1-mm-diameter) can allow for the in vivo measurement. For example, the PSD 42 could be inserted into the patient P via a nasal cavity. Thus, actual doses inside the patient's body can be measured, in some cases in real time.

In some embodiments, the teachings herein could also be applied to help protect medical staff, such as surgeons. In particular, one or more PSDs could be applied to wearable articles, such as gloves, eyewear, clothing, and so on.

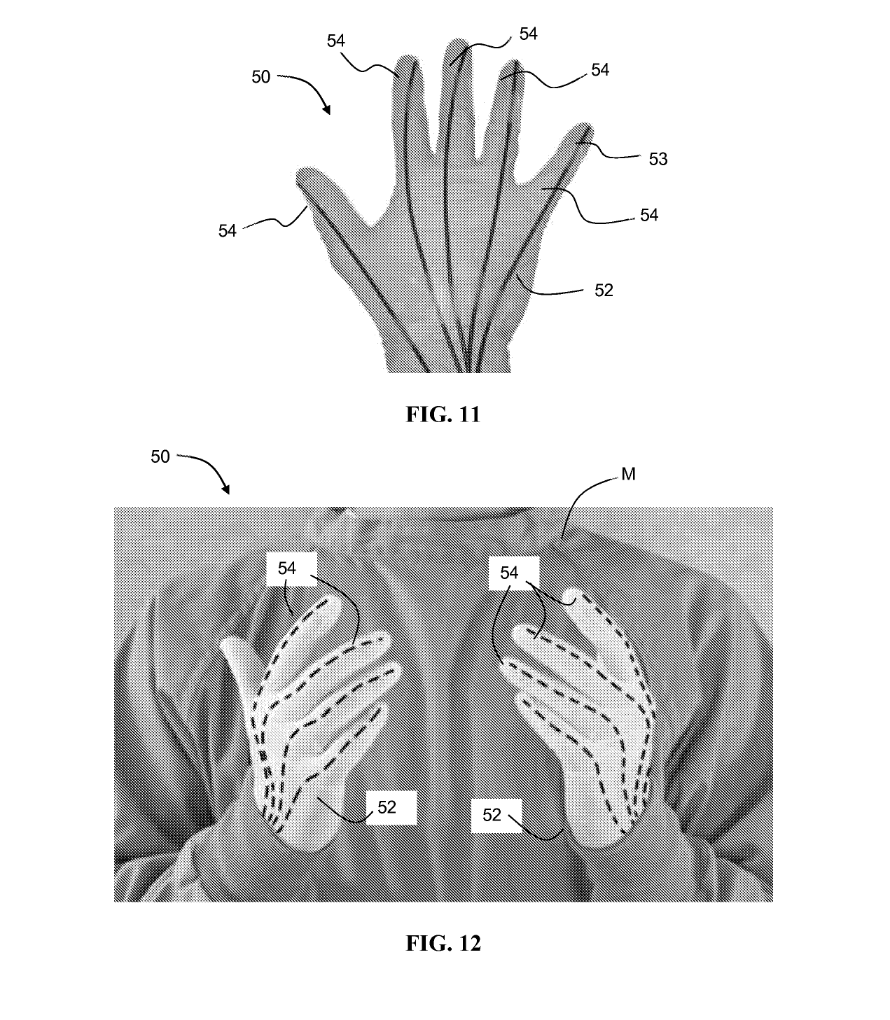

For example, FIGS. 11 and 12 show gloves 50 having a plurality of PSDs 54 coupled to the glove body 52. In some embodiments, the PSDs could run along the fingers 53 of the glove body 52.

In particular, for hand dosage measurements, the PSDs 54 could be placed on top of the glove body 52 and adapted to measure the dose received by each fingertip. Because the PSDs 54 can be made of an optical fiber that can be malleable, this setup should not interfere with the hand movements of the surgeon (or other medical staff) wearing the glove(s) 50.

In some embodiments, the PSDs 54 can be arranged as fibers that inserted in grooves within the gloves 50 or are otherwise integral within the gloves 50 (as indicated generally in FIG. 12).

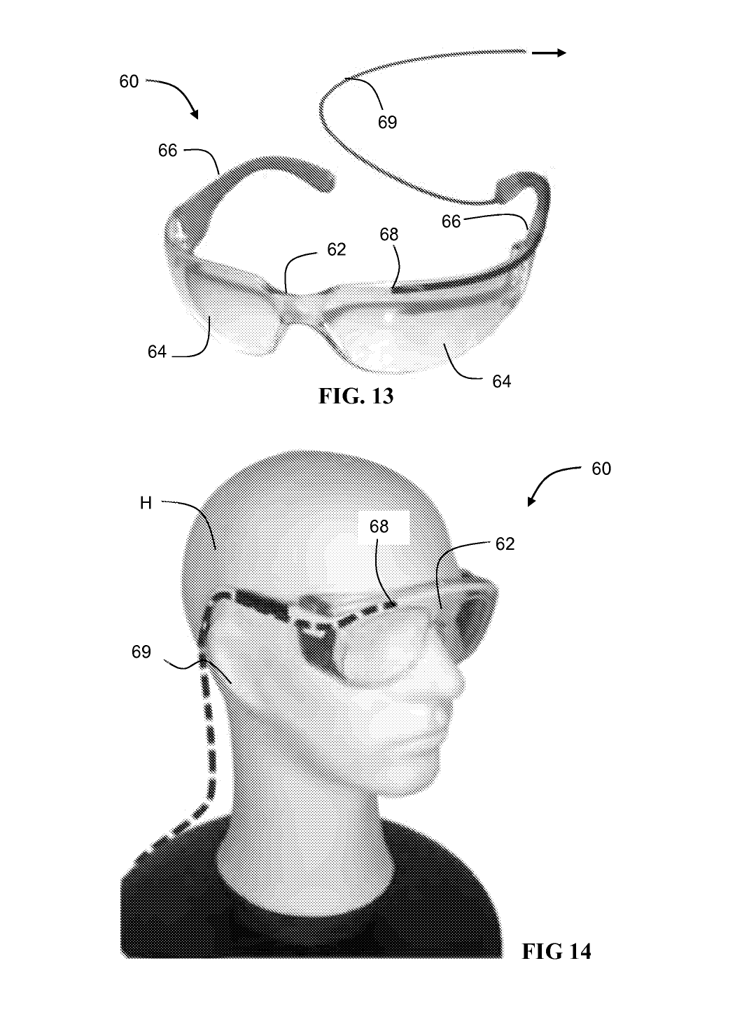

In some embodiments, PSDs could be integrated into eyewear. For example, FIGS. 13 and 14 show eyewear that include a frame 62, lenses 64 (e.g. for protecting the wearer's eyes), and arms 66 for supporting the eyewear 60 on the head H of a person (which could be a surgeon, for example).

To measure doses to the eyes, one or more PSDs 68 can be fixed on the eyewear 60 (e.g. above the lenses 64 as shown in this embodiment). The PSDs 68 can be coupled to optical fibers 66, 69 that can follow the frame 62 and arms 66 before being routed towards the control unit for processing.

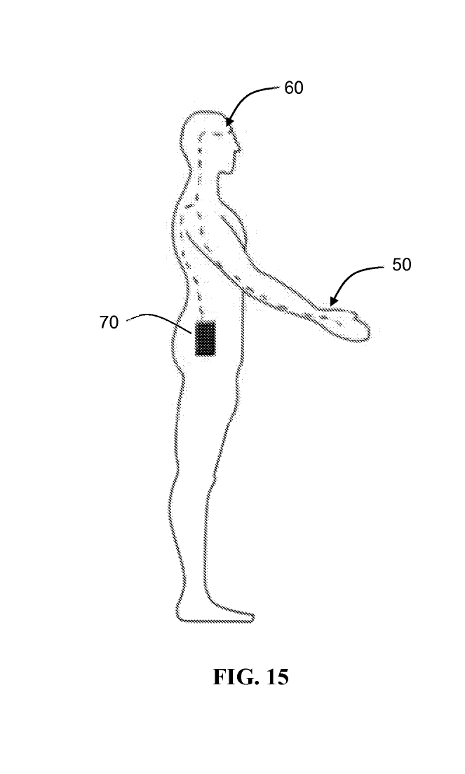

As shown in FIG. 15, the control unit 70 may also be worn by the user. For example, a user wearing gloves 50 and eyewear 60 can have a control unity 70 that is relatively small and can be clipped to a belt or another article of clothing.

Generally, the PSD dosimeters as described herein can be used for many other applications, such as measuring doses to the thyroid or other organs that may be at risk.

In various embodiments, one or more different types of photodetectors could be used with the teachings herein. For example, in some embodiments PIN diodes, Photomultipliers, Si-photomiltupliers, CCDs, and/or avalanche photodiodes could be used.

While the above description provides examples of one or more apparatus, methods, or systems, it will be appreciated that other apparatus, methods, or systems may be within the scope of the present description as interpreted by one of skill in the art.

TABLE I

| | Peak | | | |
|---|---|---|---|---|
| Energy | energy, | Anode current, | | Dose rate, |
| level | keV | mA | Filtration | R/minute* |
| 4 | 80 | 4.0 | 0.8 mmAl | 275 |
| 5 | 80 | 8.0 | 2.0 mmAl | 273 |
| 6 | 100 | 10.5 | 1.8 mmAl + 0.1 mmCu | 258 |
| 7 | 120 | 11.2 | 1.1 mmAl + 0.3 mmCu | 237 |
| 8 | 150 | 13.2 | 0.2 mmAl + 1.0 mmCu | 229 |

*Uncertainty: ±1% of dose rate.

TABLE II

| | | C_{LCT spectra} | | C_{MC} | |
|---|---|---|---|---|---|
| | | Weighted on | Weighted on | Using | Using |
| Energy | | theoretical | experimental | theoretical | experimental |
| Level | C_{LCT Eeff}* | spectrum | spectrum | spectrum | spectrum |
| 4 | 0.390 ± 0.006 | 0.420 ± 0.006 | 0.423 ± 0.006 | 0.411 ± 0.004 | 0.432 ± 0.002 |
| 5 | 0.410 ± 0.006 | 0.448 ± 0.007 | 0.458 ± 0.007 | 0.440 ± 0.003 | 0.465 ± 0.004 |
| 6 | 0.501 ± 0.008 | 0.556 ± 0.008 | 0.571 ± 0.009 | 0.549 ± 0.005 | 0.578 ± 0.006 |
| 7 | 0.700 ± 0.010 | 0.690 ± 0.010 | 0.700 ± 0.010 | 0.691 ± 0.009 | 0.710 ± 0.009 |
| 8 | 0.920 ± 0.010 | 0.870 ± 0.010 | 0.870 ± 0.010 | 0.883 ± 0.006 | 0.890 ± 0.009 |

*Using the spectrum effective energy.

TABLE III

| | Energy response, pC/Gy | | | | | |
|---|---|---|---|---|---|---|
| | | LCT | LCT | LCT | Monte Carlo | Monte Carlo |
| | | Effective | Theoretical | Experimental | theoretical | experimental |
| Energy | No | energy | spectra | spectra | spectra | spectra |
| level | correction | correction | correction | correction | correction | correction |
| 4 | 16.1 ± 0.2 | 41.0 ± 1.0 | 38.3 ± 0.9 | 38.1 ± 0.9 | 39.2 ± 0.8 | 37.3 ± 0.7 |
| 5 | 17.1 ± 0.2 | 42.0 ± 1.0 | 38.3 ± 0.9 | 37.4 ± 0.9 | 38.9 ± 0.6 | 36.9 ± 0.8 |
| 6 | 20.9 ± 0.2 | 41.0 ± 0.5 | 37.6 ± 0.9 | 36.6 ± 0.6 | 38.1 ± 0.7 | 36.2 ± 0.8 |
| 7 | 26.6 ± 0.3 | 38.0 ± 0.6 | 38.4 ± 0.7 | 37.7 ± 0.6 | 38.4 ± 0.9 | 37.4 ± 0.9 |
| 8 | 34.9 ± 0.3 | 37.8 ± 0.9 | 40.1 ± 0.6 | 39.9 ± 0.7 | 39.5 ± 0.8 | 39.2 ± 0.9 |
| Mean | 23.1 | 40.0 | 38.6 | 37.9 | 38.8 | 37.4 |
| COV | 30.0% | 4.5% | 2.1% | 2.9% | 1.4% | 2.7% |

1. A method of validating a plastic scintillating fiber (PSD), comprising:
a. using at least one PSD to obtain at least one dose measurement;
b. determining at least one PSD correction factor suitable for compensation for variations in an energy response of the at least one PSD, wherein the at least one PSD correction factor is determined according to large cavity theory (LCT);
c. determining at least one corrected dose measurement based on the at least one PSD correction factor and the at least one dose measurement by applying an effective energy correction factor C_{LCT E}_{_{eff}} to the at least one dose measurement to determine the corrected dose measurement;
d. validating the at least one PSD correction factor using at least one Monte Carlo simulation

2. The method of any preceding claim, wherein a dose in air Dₐᵢᵣ is determined based on the at least one dose measurement M_{PSD} made with the at least one PSD according to:
$${D}_{air} = {{M}_{PSD} [ \frac{\overline{{μ}_{en}}}{ρ} ]}_{polystyrene}^{air}$$

3. A method of validating a plastic scintillating fiber (PSD), comprising:
a. using at least one PSD to obtain at least one dose measurement;
b. determining at least one PSD correction factor suitable for compensation for variations in an energy response of the at least one PSD; and
c. determining at least one corrected dose measurement based on the at least one PSD correction factor and the at least one dose measurement.

4. The method of claim 3, wherein the at least one PSD is used to obtain the at least one dose measurement at energy levels of less than about 150 keV.

5. The method of claim 3, wherein the method is applied in relation to at least one of diagnostic radiology, superficial therapy and interventional radiology.

6. The method of claim 3, further comprising validating the at least one PSD correction factor using at least one Monte Carlo simulation.

7. The method of claim 3, wherein the at least one PSD correction factor is determined according to large cavity theory (LCT).

8. The method of claim 3, wherein the at least one PSD correction factor is determined according to a mass energy absorption coefficient (μen/p) ratio of the at least one PSD.

9. The method of claim 3, wherein a dose in air Dₐᵢᵣ is determined based on the at least one dose measurement M_{PSD} made with the at least one PSD according to:
$${D}_{air} = {{M}_{PSD} [ \frac{\overline{{μ}_{en}}}{ρ} ]}_{polystyrene}^{air}$$

10. The method of claim 3 further comprising applying an effective energy correction factor C_{LCT E}_{_{eff}} to the at least one dose measurement to determine the adjusted dose measurement.

11. The method of claim 10, wherein the effective energy correction factor C_{LCT E}_{_{eff}} is determined as the
$$\frac{{μ}_{en}}{ρ}$$
ratio taken at the effective energy according to
$${C}_{LCT {E}_{ff}} = {[ \frac{\overline{{μ}_{en}}}{ρ} ]}_{air}^{med} = \frac{{[ \frac{{μ}_{en}}{ρ} ( {E}_{eff} ) ]}_{med}}{{[ \frac{{μ}_{en}}{ρ} ( {E}_{eff} ) ]}_{air}}$$
where
$$\frac{{μ}_{en}}{ρ} ( {E}_{eff} )$$
is the mass energy-absorption coefficient taken for the corresponding effective energy.

12. The method of claim 3, wherein at least one PSD correction factor C_{LCT spectra} is determined by taking an average of
$${[ \frac{\overline{{μ}_{en}}}{ρ} ]}_{air}^{med}$$
weighted over the complete fluence spectra according to:
$${C}_{LCT spectra} = {[ \frac{\overline{{μ}_{en}}}{ρ} ]}_{air}^{polystyrene} = \frac{{\int }_{0}^{{E}_{max}} {( \frac{{μ}_{en}}{ρ} ( E ) )}_{polystyrene} \cdot E \cdot Φ ( E ) \cdot d E}{{\int }_{0}^{{E}_{max}} {( \frac{{μ}_{en}}{ρ} ( E ) )}_{air} \cdot E \cdot Φ ( E ) \cdot d E} ,$$
where Eₘₐₓ is the maximum incident photon energy and Φ(E) is the fluence spectrum.

13. The method of claim 3, further comprising converting a PSD response obtained from the at least one PSD to a dose-to-medium measurement for each depth according to:
$${PSD}_{corrected} ( z ) = {PSD}_{raw} ( z ) \cdot {[ \frac{\overline{{μ}_{en}}}{ρ} ]}_{PSD}^{medium} ( z )$$

14. The method of claim 3, wherein the at least one PSD correction factor includes a Monte Carlo correction factor C_{MC} determined according to:
$$\\ {C}_{MC} = \frac{{D}_{polystyrene}}{{D}_{air}} .$$

15. The method of claim 3, wherein the at least one PSD correction factor includes a correction for medium difference.

16. The method of claim 3, wherein the at least one PSD correction factor includes a correction for beam hardening.

17. A plastic scintillating fiber validated according to the method of claim 3.

18. A wearable article comprising one or more plastic scintillating fibers validated according to the method of claim 3.

19. The wearable article of claim 18, wherein the article includes gloves.

20. The wearable article of claim 18, wherein the article includes eyewear.
